(19) United States
(12) Patent Application Publication
(10) Pub. No.: US 2017/0060169 A1
(43) Pub. Date: Mar. 2, 2017

(54) Apparatus for Returning a Control to a Preset Position

(71) Applicants: Paul F. Stroh, Seattle, WA (US); Jack M. Jacobson, Walla Walla, WA (US); Jeffrey D. Jacobson, Seattle, WA (US)

(72) Inventors: Paul F. Stroh, Seattle, WA (US); Jack M. Jacobson, Walla Walla, WA (US); Jeffrey D. Jacobson, Seattle, WA (US)

(21) Appl. No.: 15/249,331

(22) Filed: Aug. 26, 2016

Related U.S. Application Data
(60) Provisional application No. 62/283,306, filed on Aug. 27, 2015.

(51) Int. Cl. G05G 5/03; G10D 1/08; G05G 5/02; F16D 1/08; G05G 1/08

(52) U.S. Cl. CPC G05G 5/03; F16D 1/0847; G05G 1/08; G05G 5/02; G10D 1/085

(57) ABSTRACT

An adjustable detent pair feature for a control knob assembly on a rotatable shaft. A first part of the detent pair has a component with a receptacle facing the underside of the control knob. The component is lockable in relation to a housing within which the shaft is engaged. A rotatable adjustment component is frictionally engaged with the control knob, and the rotatable adjustment component has as a second part of the detent pair a protruding feature facing and engagable with the receptacle. The rotatable adjustment component may thus be rotated against a frictional force to a position relative to the knob, such that the knob and the shaft to which it is attached may then be freely turned to any position, but will be temporarily inhibited when the second part of the detent pair catches on the first part of the detent pair.

### CROSS REFERENCE TO RELATED APPLICATIONS

This application claims priority to U.S. Provisional Patent application 62/283,306 filed Aug. 27, 2015, which is hereby incorporated by this reference as if fully set forth herein.

### TECHNICAL FIELD

This disclosure relates to controls having optional and selectable preset positions for ‘memorizing’ a preferred control position; more particularly, it relates to rotary control dials and their associated potentiometers.

### BACKGROUND

Electronic musical instruments are capable of significant variations in sound, much of which is determined by manual adjustments to (or rotations of) the control knobs of the various instruments. In the case of electric guitars, byway of example and not exclusion, these control knobs are typically for volume and tone. Other musical devices, including instrument amplifiers and effects units, generally have similar controls, and often many other controls as well, including treble, bass, gain, reverb, and tremolo, among others that will be well known to those skilled in the art.

Users (typically musicians) experiment with different settings on the control knobs to achieve a desired sound or effect. On some instruments, a number of combinations of the control knobs is possible. Remembering precisely where the controls were set as a preference on an instrument (or a chain of instruments in the case of an electric guitar that is plugged into an effects unit and an instrument amplifier, for example) to achieve a desired sound or effect can be challenging. In the past, musicians have recorded control settings in notebooks or used tape or other markings affixed to their instruments and devices to indicate the location of the desired and preferred settings.

A user of an electronic musical instrument may also wish to achieve a pre-selected and preferred control setting quickly and precisely, for example while playing an instrument during a musical performance. Moreover, vigorous playing techniques, such as heavy strumming on an electric guitar, for example, can cause unwanted movement of the control knobs when they are jostled or accidently brushed by a user. In these and other scenarios, having the ability to quickly locate a desired setting, often by feel and or without benefit of sight, and to secure the setting to help prevent unwanted movement of the controls, would be advantageous.

### DISCLOSURE

The disclosed apparatus solves all of these problems and also opens new possibilities for enhanced user manipulation of an instrument's control knobs.

A new type of adjustable detent feature having at least one detent pair is disclosed for enhancing user control of sound and effects settings that are common on many electronic musical devices, also called instruments. In this discussion, control knobs on musical instruments are presented byway of example and not byway of exclusion of other devices that employ rotatable control mechanisms.

The detent feature works in conjunction with most ordinary potentiometers that use rotating contacts and which use control knobs to determine volume, tone, and other characteristics of sound and effects produced by such instruments. The detent feature allows a user to pre-select any point or value within the range of rotation of a control knob so that when the control knob is turned to the selected value it meets perceptibly tactile resistance in the form of a bump, click, or catch as the detent pair interengage with each other. This interengagement of the detent pair somewhat inhibits the free rotation of the knob so that it is arrested, or comes to rest, at the selected value, giving the user an easy-to-recognize tactile or by-feel reference indicating that the desired value has been attained. The detent interengagement is then released when sufficient additional manual rotating force applied to the knob “frees” (disengages) one part of the detent pair from the other.

The detent feature and knob components are compatible with most any electronic musical instrument that uses one or more potentiometers and shaft-mounted control knobs, including electric guitars and basses, instrument amplifiers, effects units (including pedals), and many other devices. To illustrate, a user may rotatably set the second part of detent pair 10 to a value of “5” on a volume knob that has a values range of 0 to 10. Doing so will allow the user to predictably locate by feel the value of “5” simply by turning the knob and feeling for the arrest or interengagement of the detent pair. The resistance provided by the engaged detent pair in turn permits a stable setting for the control, allowing the user to quickly achieve and maintain the desired setting, even during challenging conditions that may include poor lighting or vigorous playing of an instrument.

The detent feature thus provides an easily achieved adjustment that a user can quickly and reliably (precisely) set to any value within the range of rotation on a potentiometer and knob which provides an easily discernible (tactilely felt) resistance in the form of a bump, click, or catch, so the user can identify the selected value simply by rotating the control knob without the need for a visual reference that the value has been attained. It also advantageously provides a visual reference that indicates to the user at a glance the value adjustably selected for engagement of the detent feature on the control knob. Further, it provides a stable setting control that, once engaged, serves to hold, or secure, the selected control knob in place to forestall unwanted movement of the control. The disclosed feature is compatible with most existing setting or control assemblies, such as the potentiometers and knobs that are commonly used on electronic musical devices, and can be easily and quickly installed on such devices.

The components of the detent feature include:

a washer or like piece with a groove or other receptacle facing the underside of a control knob;

a rotatable adjustment component that attaches to or frictionally engages with the control knob;

a tooth, prong, pin, rounded-ball shape, or other similar type of protruding feature which is connected to or integral with the rotatable adjustment component. In some embodiments the male-female nature of the two detent pair parts are reversed.

The rotatable adjustment component may attach to or be integrated with the control knob in a variety of ways. It may be preformed to press outwardly against the knob's interior sidewall, or it may be preformed to grip the exterior of the knob's interior potentiometer shaft engaging cylinder (a structure with a hollow cylinder inside the knob that fits on to a potentiometer shaft), or it may otherwise attach to or be a part of a surface, section, or feature of the knob.

An aspect of the attachment or integration of the rotatable adjustment component is the incorporation of a friction load to create turning resistance when a user attempts to adjust the position of the component. This resistance is adequate to retain the component at a specific selected location or value in relation to the knob, and it also permits the component to rotate relative to the knob when a user applies sufficient turning force against the frictional resistance (while holding the knob steady and immobile) to change the detent value selected. It is believed that persons skilled in the art will be familiar with materials and arrangements of materials and parts for producing such a friction load, the frictional resistance against which the disclosed rotatable adjustment component is turned.

In addition, the rotatable adjustment component employs a spring force (of a sort that will be known to those skilled in the art) that produces downward pressure on the protruding feature such that the feature is urged into a resting position when it passes into the groove in the washer.

### BRIEF DESCRIPTION OF THE DRAWINGS

FIG. 1 is an exploded view of one embodiment of the detent feature.

FIG. 2 is a side view of the detent feature showing the detent catch mechanism in an arrested state.

FIG. 3 is an exploded view of an alternate embodiment of the detent feature.

FIG. 4 is an exploded view of the embodiment shown in FIG. 3 that provides additional detail.

FIG. 5 is an exploded view of a further alternate embodiment of the detent feature.

FIG. 6 is a detail alternate view of an aspect of FIG. 5.

### DETAILED DESCRIPTION

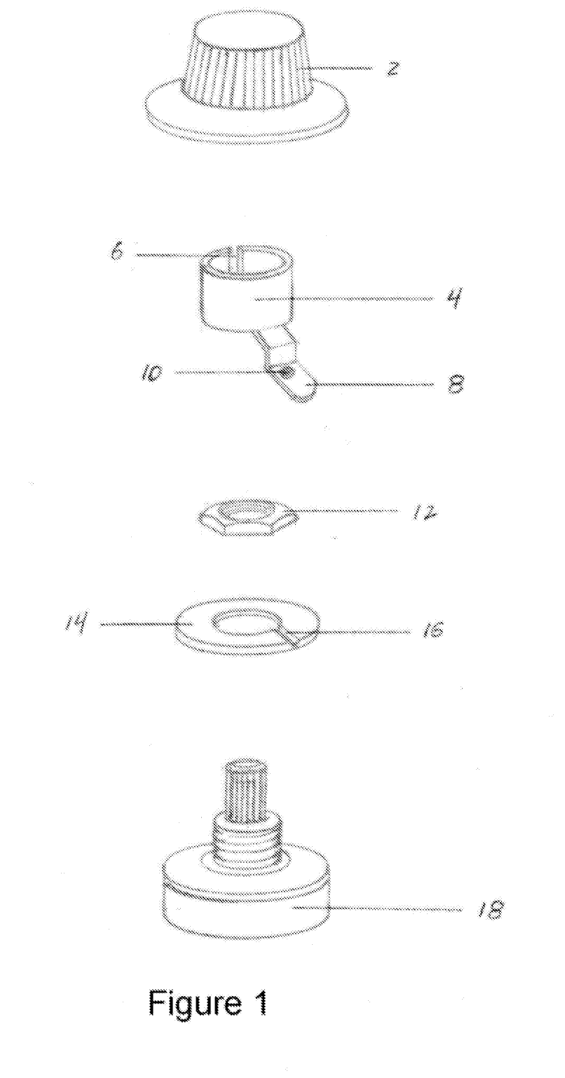

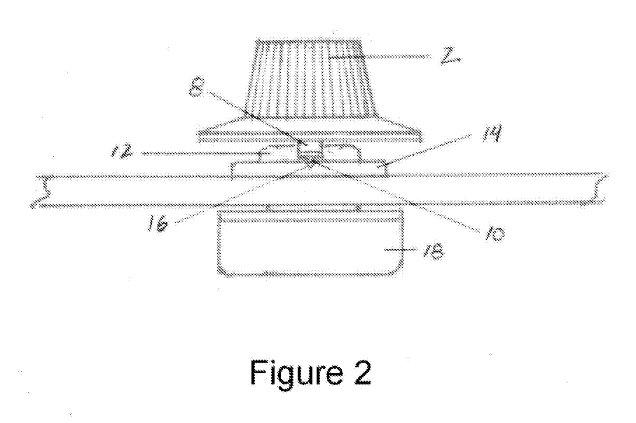

In one embodiment shown in FIG. 1 and FIG. 2, friction-loaded rotatable adjustment component 4 with gap 6 fits snugly into interior cavity (not shown but well known) of control knob 2. Washer 14 or the like with first part of detent pair 16 (for example, a groove) replaces a standard washer that is commonly used in a potentiometer and knob assembly. The washer with first part of detent pair 16, along with potentiometer and shaft 18, are secured to an electronic musical device by nut 12. When properly secured by the nut the washer remains tightened in place, achieving a fixed location for first part of detent pair 16. In this embodiment, an adjustment arm 8, desirably integral with adjustment component 4, and made from spring steel or other suitably flexible spring material, is used to rotate the rotatable adjustment component against frictional resistance separate from rotation of knob 2. Second part of detent pair 10 is desirably located on a side of adjustment arm 8 facing the washer and nut. The detent pair is engaged when knob 2 is turned, rotating with it adjustment component 4 and adjustment arm 8 and second part of detent pair 10 to bring it into engagement with first part of detent pair 16. In the illustration, second part of detent pair 10 is advantageously a protruding feature such as a bump or rounded pin, shown (FIG. 2) in mated or engaged relationship with groove 16.

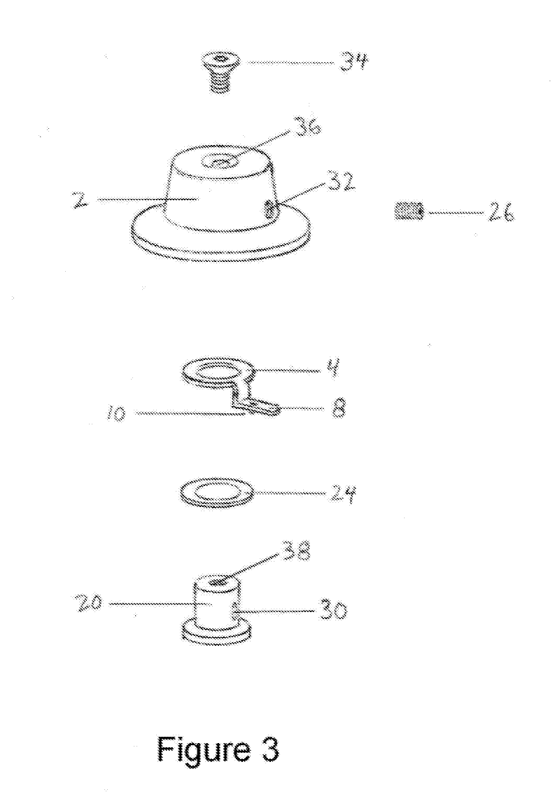

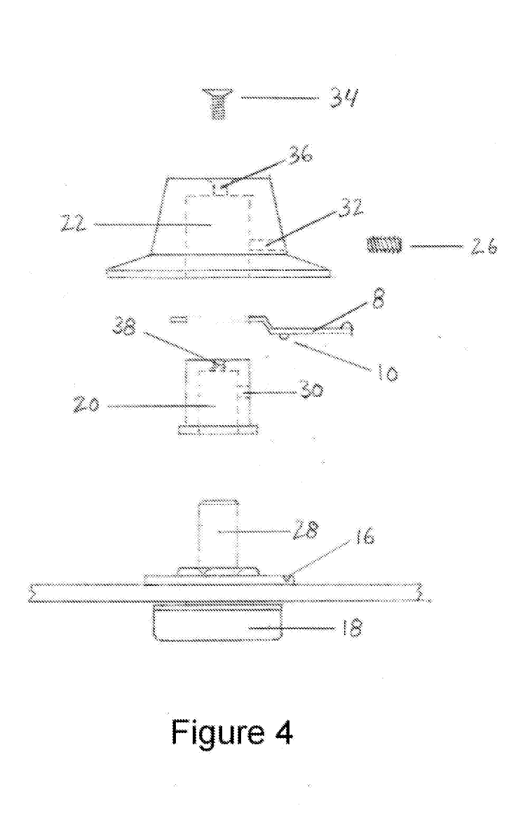

In FIGS. 3 and 4 an alternate embodiment is illustrated. Optional friction washer 24 (e.g., a crinkle, wave, spring, or similar washer type) and rotatable adjustment component 4 fit down onto sleeve 20. Sleeve 20, with the washer and rotatable adjustment component, slides into interior cylinder 22 (FIG. 4) of control knob 2. Set screw 26 threads into threaded opening 32 in knob 2 and attaches the knob to the sleeve. The set screw may optionally be configured, as shown, to secure the knob and sleeve to potentiometer shaft 28 through opening 30 in the sleeve. Detent tension adjustment screw 34 passes through opening 30 and into threaded opening 38 in sleeve 20. Tightening or loosening the tension adjustment screw increases or decreases friction on the rotatable adjustment component, allowing a user to fine tune the amount of turning resistance desired for adjusting the position of the detent.

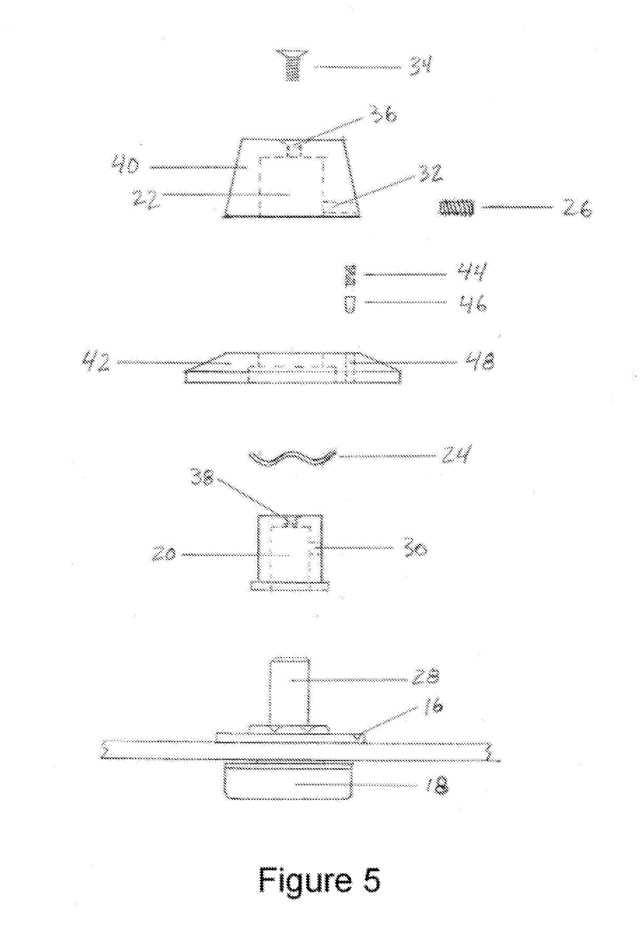

In FIG. 5 another embodiment of the detent feature is illustrated. The control knob is split into top section 40 and bottom section 42. In this embodiment, bottom section 42 serves as the friction-loaded rotatable adjustment component while only top section 40 is secured to the potentiometer shaft. To adjust the preset value for the detent pair to engage, a user rotates the bottom section of the knob relative to the top section. Spring 44, which is held in place by the top section of the knob, is compressed to bias rounded pin 46 against washer 16. This pin passes through opening 48 and serves as the protruding feature of the second part of the detent pair.

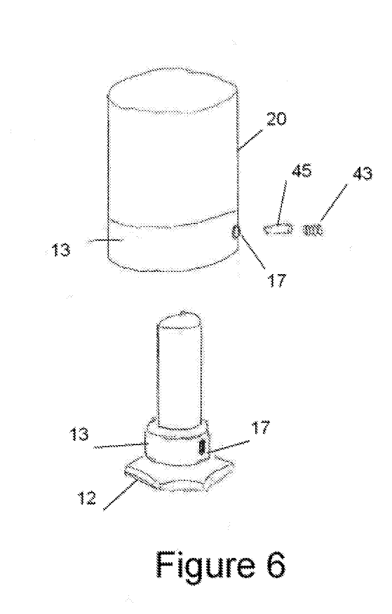

In FIG. 6 some alternate details illustrate placement of fixed groove or notch 17 on a vertical (as opposed to horizontal) surface of collar 13, which can advantageously be a sleeve connected to nut 12 or a washer that extends upward from the base of potentiometer shaft 28. Spring-loaded pin 45 is biased by spring 43 as the first part of the detent pair. Sleeve 20 is attached to the shaft and to the knob and turns independently of collar 13.

In general, to adjust the detent feature once installed, a user manually turns the rotatable adjustment component relative to the top part of the knob until a desired value is achieved. Once set, the knob will turn freely, along with the adjustment component until the two parts of the detent feature engage to arrest the turning of the control knob at the desired setting.

Alternative further embodiments of the detent feature are contemplated, including but not limited to the following:

The rotatable adjustment component may take any form and employ any material that creates sufficient friction to retain a stable value, or position, relative to a control knob, while still permitting a user to rotate the adjustable component against that friction as the knob is held. Materials or combinations of materials may include spring steel, wire, aluminum, and plastic, among others.

The rotatable adjustment component may be used hi conjunction with a range of specially configured control knobs having features designed to integrate with the detent pair assembly and enhance its operation.

The detent may provide more than one pre-selected setting if desired. For example, two rotatable adjustment components, each with its own adjustment mechanism and each with its own protruding feature may be used in conjunction with a washer still having only one groove. For example, one rotatable adjustment component presses outwardly on the interior sidewall of control knob and the other grips, or is otherwise frictionally engaged with the interior cylinder of the knob, each component capable of providing a unique detent value and each independent of the other in operation. Specially configured control knobs offer additional options for integrating more than one rotatable adjustment component.

The washer with a groove may be replaced or supplemented by any other component that provides the capability to receive or hold the protruding feature of the catch mechanism in place, including a nut or threaded washer with a groove, a ring with a groove and an adhesive backing in the form of a washer that is affixed to the surface of the instrument or to the existing washer in a potentiometer and knob assembly, a ring with a groove and an interior cutout that matches the measurement dimension of the nut (for example, inch or 13 mm) used to hold the potentiometer and knob assembly so (hat the ring's interior cutout slips precisely over the nut's measurement dimension to retain the groove in a fixed position.

Alternate embodiments also include placement of a fixed groove or notch on a vertical (as opposed to horizontal) surface, such as on a sleeve connected to a nut or washer that extends upward from the base of the potentiometer shaft (see FIG. 6 and discussion above).

Another alternative is to reverse the components of the detent pair so that the washer and its receptacle becomes the moveable piece and the second part of the detent pair, while the detent pin (or the like structure) is “fixed” to the knob in a single location (such as the spring-loaded pin but with no other moving parts on the knob) as the first part of the detent pair. A “moveable” detent connected to a such washer assembly requires only that the mechanics be basically the same but reversed.

It Is contemplated that the rotatable adjustment component can take other forms than those described above. For example, and in a variation of the embodiment shown in FIG. 5, it can be located on top of the control knob. With the guidance provided by this disclosure, such a further variation will be within the capabilities of those skilled in the art, without departing from the scope of this disclosure. Some guitar pedals have quite small knobs that can be close together, making the addition of a functional pointer (as shown in the application) a challenge to accomplish. A “pointer” on top of the knob would solve this. One way to do this would be with the two-part knob, where the top of the knob turns relative to the bottom of the knob. But in this variation, turning the top of the knob moves the rotatable adjustment component with the second part of the detent pair to change the setting for the detent, while the bottom part of the knob, mechanically linked to the shaft, changes the control knob setting.

It should be noted that the second part of the detent pair located on the rotatable adjustment component does not necessarily need to be located near the visible pointer, where such a visible pointer is provided.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted hi accordance with the doctrine of equivalents.

We claim:

1. In an control knob assembly on a rotatable shaft, the improvement comprising:
an adjustable detent pair feature, a first part of the detent pair further comprising a component with a receptacle facing the underside of the control knob, the component lockable in relation to a housing within which the shaft is engaged; and
a rotatable adjustment component frictionally engaged with the control knob, the rotatable adjustment component having as a second part of the detent pair a protruding feature facing and engageable with the receptacle;
whereby the rotatable adjustment component may be rotated against a frictional force to a position relative to the knob, such that the knob and the shaft to which it is attached may then be freely turned to any position, but will be arrested when the second part of the detent pair engages with the first part of the detent pair.

2. The assembly of claim 1 wherein an amount of rotationally applied force required to turn the rotatable adjustment component within the knob is selectably adjustable with a friction adjustment component selected from the group of friction adjustment components consisting of a screw tightened against a spring washer, spring collar bent inwards to engage the control knob's internal shaft-engaging cylinder, and a spring collar bent outwards to engage the control knob's internal sidewalls.

3. The assembly of claim 1 wherein the rotatable adjustment component comprises a preformed split collar that presses outwardly against the knob's interior sidewall.

4. The assembly of claim 1 wherein the rotatable adjustment component comprises a preformed split collar that grips the exterior of the knob's interior potentiometer shaft engaging cylinder.

5. A musical instrument control knob assembly on a rotatable shaft, the assembly comprising:
an adjustable detent pair feature, a first part of the detent pair further comprising a washer with a receptacle facing the underside of the control knob, the washer lockable in relation to a housing within which the shaft is engaged; and
a rotatable adjustment component frictionally engaged with the control knob, the rotatable adjustment component having as a second part of the detent pair a protruding feature facing and engagable with the receptacle;
whereby the rotatable adjustment component may be rotated against a frictional force to a position relative to the knob, such that the knob and the shaft to which it is attached may then be freely turned to any position, but will be arrested when the second part of the detent pair engages with the first part of the detent pair.

6. The assembly of claim 5 wherein an amount of rotationally applied force required to turn the rotatable adjustment component within the knob is selectably adjustable with a friction adjustment component selected from the group of friction adjustment components consisting of a screw tightened against a spring washer, spring collar bent inwards to engage the control knob's internal shaft-engaging cylinder, and a spring collar bent outwards to engage the control knob's internal sidewalls.

7. The assembly of claim 5 wherein the rotatable adjustment component comprises a preformed split collar that presses outwardly against the knob's interior sidewall.

8. The assembly of claim 5 wherein the rotatable adjustment component comprises a preformed split collar that grips the exterior of the knob's interior potentiometer shaft engaging cylinder.

9. The assembly of claim 5 further comprising a spring washer and a sleeve for the shaft; wherein the rotatable adjustment component fits down onto the sleeve and the sleeve, the washer and the rotatable adjustment component slide as a subassembly into an interior cylinder of the knob.

10. The assembly of claim 9 further comprising a set screw threaded into an opening in the knob that attaches the knob to the sleeve.

11. The assembly of claim 9 further comprising a detent tension adjustment screw that passes through an opening in the knob and into a threaded opening in the top of the sleeve, whereby tightening or loosening the tension adjustment screw increases or decreases friction on the rotatable adjustment component, allowing a user to fine tune the amount of turning resistance desired for adjusting the position of the detent.

12. The assembly of claim 5 further comprising the knob being split into a top section and a bottom section, wherein the bottom section serves as the friction-loaded rotatable adjustment component while only the top section is secured to the potentiometer shaft.

13. The assembly of claim 12 further comprising a spring held in place by the top section of the knob and compressed to bias a rounded pin against the washer, the pin passes through an opening in the bottom section and serving as the protruding feature of the second part of the detent pair.

14. A musical instrument control knob assembly on a rotatable shaft, the assembly comprising:
an adjustable detent pair feature, a first part of the detent pair further comprising a washer with a receptacle facing the underside of the control knob, the washer lockable in relation to a housing within which the shaft is engaged; and
a rotatable adjustment component frictionally engaged with the control knob, the rotatable adjustment component having as a second part of the detent pair a protruding feature facing and engageable with the receptacle;
whereby the rotatable adjustment component may be rotated against a frictional force to a position relative to the knob, such that the knob and the shaft to which it is attached may then be freely turned to any position, but will be arrested when the second part of the detent pair engages with the first part of the detent pair;
the assembly further comprising a spring washer and a sleeve for the shaft; wherein the rotatable adjustment component fits down onto the sleeve and the sleeve, the washer and the rotatable adjustment component slide as a subassembly into an interior cylinder of the knob.

15. The assembly of claim 14 further comprising a set screw threaded into an opening in the knob that attaches the knob to the sleeve.

16. The assembly of claim 14 wherein an amount of rotationally applied force required to turn the rotatable adjustment component within the knob is selectably adjustable with a friction adjustment component selected from the group of friction adjustment components consisting of a screw tightened against a spring washer, spring collar bent inwards to engage the control knob's internal shaft-engaging cylinder, and a spring collar bent outwards to engage the control knob's internal sidewalls.
